(19) United States
(12) Patent Application Publication
(10) Pub. No.: US 2004/0010651 A1
(43) Pub. Date: Jan. 15, 2004

(54) Field bus system for controlling safety-critical processes

(76) Inventor: Alexander Wiegert, Leinfelden-Echterdingen (DE)

Correspondence Address: HARNESS, DICKEY & PIERCE, P.L.C., P.O. BOX 828, BLOOMFIELD HILLS, MI, 48303, US

(21) Appl. No.: 10/426,430

(22) Filed: Apr. 29, 2003

Related U.S. Application Data
(63) Continuation of application No. PCT/EP01/12156, filed on Oct. 22, 2001.

(30) Foreign Application Priority Data
Oct. 30, 2000 (DE) 100 53 763.4

(51) Int. Cl. G06F 13/14

(52) U.S. Cl. 710/305

(57) ABSTRACT

The present invention relates to a field bus system for controlling safety-critical processes. The system has an open channel transmission medium and a plurality of bus subscribers connected to the transmission medium. The bus subscribers are configured to transmit bus messages via the transmission medium in order to communicate with each other. The system further has a defined communication protocol which predetermines rules for the transmission and reception of bus messages. The communication protocol includes an individual system identifier which is connected at least to each bus message transmitted via the open communication channel.

### CROSS-REFERENCES TO RELATED APPLICATIONS

This application is a continuation of copending international patent application PCT/EP01/12156 filed on Oct. 22, 2001 designating the U.S. and published in German language, which PCT application claims priority from German patent application DE 100 53 763.4, filed on Oct. 30, 2000.

### BACKGROUND OF THE INVENTION

The present invention relates to a field bus system for controlling safety-critical processes, and in particular to a field bus system having a transmission medium and a plurality of bus subscribers, which are connected to the transmission medium, wherein the bus subscribers are capable of transmitting bus messages via the transmission medium in order to communicate with each other, and further having a defined communication protocol, which predetermines rules for the transmission and reception of bus messages.

The invention also relates to a bus connection module for use in such a field bus system, having an interface for connecting to a transmission medium and having a communication unit in which a communication protocol is implemented.

A field bus system is an apparatus for data communication, in which the individual bus subscribers are connected to a common transmission medium. The bus subscribers can communicate with each other by accessing the common transmission medium in accordance with defined rules. Messages are transmitted between the bus subscribers in the form of so-called bus messages. The sum total of the defined rules, for example the allocation of priorities for avoiding transmission conflicts or the nature of the addressing of bus messages, results in the defined communication protocol. Each bus subscriber has a bus connection module, in which the rules required to carry out the communication process are implemented. Known field bus systems are the so-called CAN bus, the so-called Profibus, and the so-called Interbus.

Due to their common transmission medium, field bus systems have the advantage that a plurality of bus subscribers can be connected to each other with a comparatively low level of wiring complexity. This saves time and money for installation and, furthermore, allows the installation to be matched in a flexible manner to new requirements.

The present assignee has developed a field bus system which, in contrast to the generally known field bus systems cited above, can be used for controlling safety-critical processes. In the following text, this means a process which results in an unacceptable danger to people or material goods when a fault occurs. Examples of such processes are the evaluation and monitoring of emergency-stop switches, two-handed controllers, guard doors or light barriers. The systems and equipment which are used for controlling such processes in many countries require special approval from responsible supervisory authorities. Approval criteria applied include, for example, the European Standard EN 954-1 or the German Standard DIN 19 250. Equipment and systems which comply at least with Category 3 of European Standard EN 954-1 are referred to in the following text as being “safe”.

The present assignee's field bus system even complies with the requirements for the highest Safety Category 4 of European Standard EN 954-1. It is thus accepted for controlling virtually all safety-critical processes. At the same time, the system has the advantage that a large number of safe devices, such as a safe control unit, safe input/output devices and light barriers, can be connected with limited wiring complexity to form a complex, safe control system. However, a certain amount of wiring complexity remains for fail-safety reasons, because the system exclusively uses cable-based transmission media laid for a dedicated purpose, i.e. electrical and/or optical cables. The assignee's safe field bus system is thus based on an intrinsically closed communication channel, to which only the registered safe bus subscribers have access.

### SUMMARY OF THE INVENTION

Against this background, it is an object of the present invention to provide a safe field bus system which requires an even further reduced wiring complexity.

It is another object of the invention to provide a safe field bus system which can be implemented on existing cabling hardware, even if the existing cabling hardware is already used for non-safe purposes.

It is an particular object of the present invention to provide a safe field bus system which can be implemented on an already existing Ethernet communication hardware.

Yet another object of the invention is to provide a method of safely controlling safety-critical processes with a plurality of spatially distributed bus subscribers connected to a common transmission medium.

According to one aspect of the invention, these and other objects are achieved by a field bus system as initially cited, with the transmission medium comprising an open communication channel and the communication protocol including an individual system identifier, which is connected at least to each bus message to be transmitted via the open communication channel.

These objects are furthermore achieved by a bus connection module of the type mentioned initially, in which the interface is an open communication interface, and in which the implemented communication protocol includes an individual system identifier, which is connected to a bus message to be transmitted.

In contrast to the existing field bus systems, the field bus system according to the invention includes, as a transmission medium, an open (not closed) communication channel which is basically accessible for communication subscribers of other communication links. In particular, this may include an existing, standardized cable connection, such as an Ethernet connection for an existing computer network, or a radio connection. In the latter case, the transmission medium includes a radio channel, while in the situation mentioned first, it includes an (existing) Ethernet connection.

In a manner which is startling in the field of safety engineering, the inventive field bus system for the first time and in contrast to all previous approaches departs from the principle that a safe system must be intrinsically closed in order to reliably suppress external influences and in order to ensure the required intrinsic fail-safety. Infringing all the previous principles, the inventor has recognized that the required intrinsic safety can be achieved even with a transmission medium which is not intrinsically safe due to its open nature by implementing an individual system identifier in the communication protocol and thus producing a “virtually” closed system. The individual system identifier identifies the field bus system as an entity uniquely over other field bus systems, even if they are of the same type. On the one hand, the system identifier can be set individually, so that different individual system identifiers can be assigned to different field bus systems. Moreover, the individual system identifier can be uniquely and permanently allocated to a defined field bus system as an entity, so that the bus messages which are associated with this field bus system can be safely distinguished from those from any other communication connection. It is thus possible to preclude any confusion between bus messages, even between field bus systems of the same type. In consequence, despite the use of the open and thus not intrinsically safe transmission system, the new field bus system is a safe system which is “shut off” from other bus messages.

On the other hand, the field bus system according to the invention can use existing cable connections, even those which are used for other purposes, or even wireless radio connections and thus provide the same high level of fail-safety as the field bus system cited initially, but with an extremely low level of wiring complexity. It can likewise be used in the same way as this safe field bus system for controlling safety-critical processes.

The bus connection module according to the invention includes the required interface for communication via the open (standard) communication channel as well as the individual system identifier, to which a bus message to be transmitted is connected in order to achieve the virtually closed system. A bus connection module like this allows the inventive field bus system to be set up very easily and, in addition, with a capability to access already existing standardized technologies.

In a preferred refinement to the invention, the individual system identifier is intrinsically redundant.

In this refinement of the invention, the individual system identifier includes at least two mutually redundant component elements, which have to be transmitted and received jointly in order to allow effective identification of the associated bus message. The components may, for example, be two data values which have a defined relationship with one another. One data value is in this case preferably a checksum which is derived from the other, for example a CRC (cyclic redundancy check) checksum. This measure has the advantage that the individual system identifier has a higher level of intrinsic safety, thus further improving the fail-safety of the overall system.

In a further refinement of the invention, the individual system identifier includes a defined frequency system, which is transmitted with the bus message via the open communication channel.

In this refinement of the invention, at least a portion of the individual system identifier is in the frequency domain. This can be done particularly easily when transmitting the bus message by adding an additional, individually determined “tone” to the message spectrum to be transmitted. This measure has the advantage that the system identifier is independent of the bus message to be transmitted. The system identifier is thus independent of the data errors which can influence the bus message to be transmitted. In consequence, even a bus message which is transmitted with errors can always be uniquely associated with the relevant field bus system.

In a further refinement of the invention, the individual system identifier includes a data value which is transmitted as a component of the bus message.

In this refinement of the invention, the individual system identifier is added as a data value to the bus message which is actually to be transmitted. On the one hand, this may be done within one data frame, which is provided by the bus message. The individual system identifier is, however, preferably attached “externally” to the existing data frame since, in this case, there is no need to change the data frame itself. The individual system identifier can thus be added very easily, even with relatively old existing communication protocols. In both cases, the individual system identifier can be produced using measures which are known per se, thus representing a very cost-effective and flexible possibility.

In a further refinement of the measure mentioned above, the data value is autonomously protected against data errors.

This measure has the advantage that the individual system identifier is independent of data protection measures, which the communication protocol provides as standard. This means that it is very simple to implement the individual system identifier even in an existing communication protocol. In this case, the original communication protocol may intrinsically remain unchanged, and just has the individual system identifier added to it. Protection against data errors is preferably provided by means of a CRC checksum or some comparable checksum, which is produced in addition to the already existing checksums.

In a further refinement of the invention, the transmission medium also comprises a closed communication channel, which is connected to the open communication channel via a signal converter.

In this refinement, the field bus system according to the invention has both open and closed transmission paths. This measure has the advantage that the field bus system according to the invention can always be optimally matched to existing circumstances. By way of example, a closed, cable-based part may be installed in physical areas where the electromagnetic interference radiation is particularly strong while, at the same time, longer transmission distances in other areas can be bridged without the use of wires. A greater transmission rate can also be achieved with a closed, cable-based transmission medium with comparable cost, at least based on the existing prior art. The field bus system according to the invention thus in each case profits from the advantages of the different transmission medium.

In a further refinement of the measure mentioned above, the signal converter comprises a first safety stage, which connects a bus message to be transmitted via the open communications channel to the system identifier.

This measure has the advantage that the bus subscribers in the closed part of the field bus system no longer need to provide the system identifier for a bus message that is to be transmitted. This increases their processing speed. Furthermore, an already existing closed field bus system can in this way be upgraded very cost-effectively by adding open, for example wireless, transmission sections.

In a further refinement, the signal converter comprises a second safety stage, which checks the system identifier of a bus message which is received via the open communication channel.

In this refinement, the signal converter also carries out the second task element which is associated with the individual system identifier, namely of checking it when a bus message is received. The bus subscribers in the closed part of the field bus system can thus be completely relieved from the tasks which are associated with the system identifier. The closed part of the safe field bus system can thus, for example, have wireless transmission paths easily added to it, by means of the signal converter.

In a further refinement, the signal converter comprises a filter stage, which selects bus messages to be transmitted via the open communication channel.

In this refinement, the signal converter has the capability to transmit only those bus messages via the open communication channel which are intended for bus subscribers “at the other end” of this channel. Bus messages whose addressees are not located at the other end of the open communication are not transmitted. This measure has the advantage that the open communication channel is relieved from the load of unnecessary bus messages, thus allowing a higher transmission speed.

In a further refinement, the signal converter has a interchangeable storage medium on which the system identifier is stored in a non-volatile manner.

The interchangeable storage medium is preferably a smart card. The measure has the advantage that the individual system identifier can be assigned to the signal converter very easily and nevertheless in a fail-safe manner. A defective signal converter can likewise be replaced easily and at low cost. In addition to the system identifier, a checksum which is associated with it is preferably also stored on the interchangeable storage medium, thus allowing particularly fail-safe association with the system identifier.

In a further refinement of the invention, each bus subscriber has an interchangeable storage medium on which the system identifier is stored in a non-volatile manner.

This measure allows simple and cost-effective integration of bus subscribers in the field bus system according to the invention, and to be precise particularly when the bus subscribers themselves require the system identifier in order to take part in the data communication.

In a further refinement, an individual subscriber address is also stored in a non-volatile manner on the interchangeable storage medium.

The assignment of an individual subscriber address to a bus subscriber is a safety-critical measure in the case of the field bus systems that are relevant here, because confusion must be avoided as a primary factor whenever the system is started up and in all circumstances, even those which are only feasible. This can be achieved very easily and nevertheless reliably with the proposed measure.

It is self-evident that the features mentioned above and those which are still to be explained in the following text can be used not only in the respectively stated combination but also in other combinations or on their own without departing from the scope of the present invention.

### BRIEF DESCRIPTION OF THE DRAWINGS

Exemplary embodiments of the invention will be explained in more detail in the following description and are illustrated in the drawing, in which:

FIG. 1 shows a first exemplary embodiment of the invention, in which two inventive field bus systems of the same type and having an open radio channel are arranged physically adjacent to one another, and

FIG. 2 shows a second exemplary embodiment of a field bus system according to the invention.

### DETAILED DESCRIPTION OF PREFERRED EMBODIMENTS

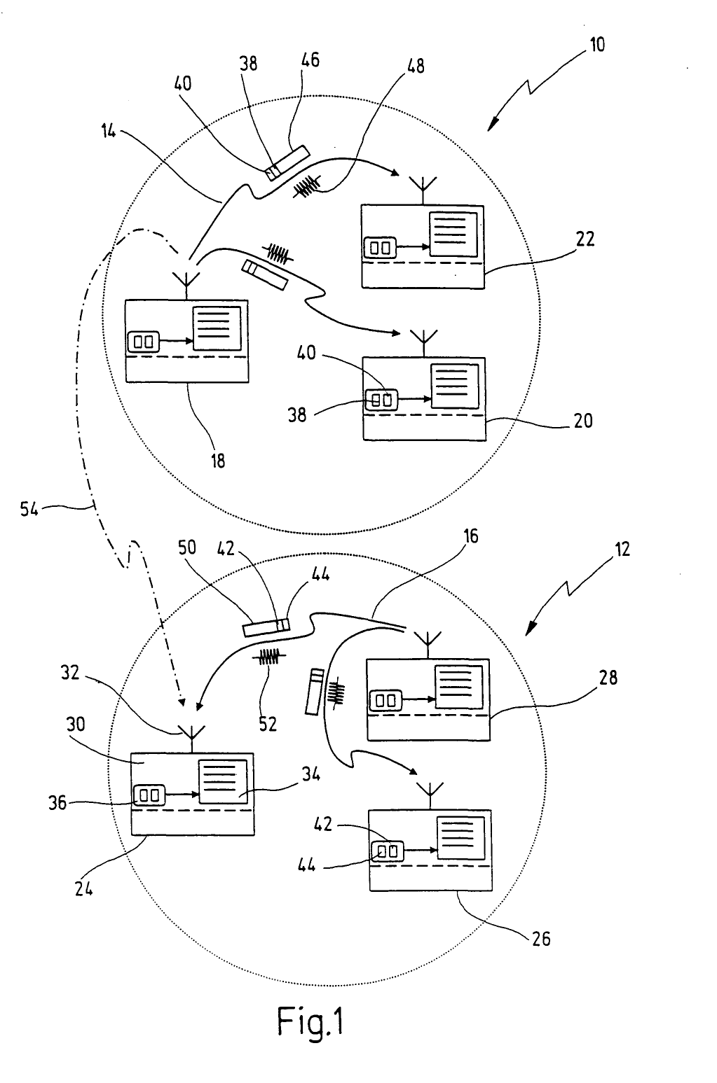

In FIG. 1, two field bus systems according to the invention are annotated in their totality by the reference numbers 10 and 12.

Each of the two field bus systems 10, 12 includes a radio channel 14 or 16, respectively, as a transmission medium, i.e. an open communication channel which is not intrinsically safe. In another exemplary embodiment, the two field bus systems 10, 12 could alternatively be provided jointly on an existing Ethernet connection, or else on some other open network connection.

By way of example, three bus subscribers are shown for each field bus system 10, 12 and they are annotated by the reference numbers 18, 20, 22 and 24, 26, 28, respectively. Each bus subscriber 18 to 28 has a bus connection module 30 with an antenna 32, which forms an interface to the respective radio channels 14 and 16. Furthermore, each bus connection module 30 has a communication unit 34, in which a communication protocol is implemented. Finally, each bus connection module 30 includes a card reader for reading a smart card 36.

Individual data value and associated checksum are stored on each of the smart cards 36. These are both components of an individual system identifier and are associated with the bus systems 10 and 12, and more precisely with the respectively associated bus subscribers 18 to 22 and 24 to 28.

In the case of bus system 10, the data value is annotated schematically by reference number 38, and the checksum is annotated by reference number 40 (annotated with bus subscriber 22 representative of all the other bus subscribers). All the bus subscribers 18 to 22 of the bus system 10 have the same associated data value 38 and the same associated checksum 40. This means that the smart cards 36 are the same for all the bus subscribers 18 to 22. By way of example, it is assumed here that the data value 38 is “0815” for all the bus subscribers 18 to 22.

In the case of the bus system 12, the data value is schematically annotated by the reference number 42, and the checksum is annotated by the reference number 44 (annotated with bus subscriber 26 representative of all the other bus subscribers). All the bus subscribers 24 to 28 have the same associated data value 42 and the same associated checksum 44. By way of example, the data value 42 is “4711” for all the bus subscribers in this case.

In this case, the bus subscribers 18 to 28 are all safe bus subscribers and they are used for controlling safety-critical processes, for example for monitoring emergency-stop switches on a complex machine system. In this case, the field bus system 10 is associated with a first machine system (not shown), while the field bus system 12 is associated with a second machine system (which is likewise not shown), which is independent of the first. The machine systems are, for example, production lines arranged alongside one another in a shared production building.

The bus subscribers 18 to 22 and 24 to 28 of the respective field bus systems 10, 12 communicate with one another via radio channels 14, 16. In the situation illustrated in FIG. 1, bus subscriber 18 transmits a bus message 46, which can be received and evaluated by bus subscribers 20 and 22. In the illustrated exemplary embodiment, the bus message 46 has the data value 38 (“0815”) and the checksum 40 added at the end of its data frame. Furthermore, the bus connection module 30 in the exemplary embodiment shown here produces a defined frequency signal 48, which is transmitted via the radio channel 14 at he same time as the bus message 46. Together with the data value 38 and the checksum 40, the frequency signal 48 forms the individual system identifier for the field bus system 10, thus making it possible to carry out an intrinsically redundant check on each received bus message 46 to determine whether this message is associated with the field bus system 10.

In a comparable manner, the bus subscriber 26 in the field bus system 12 transmits a second bus message 50 in the situation illustrated in FIG. 1, to which the data value 42 (“4711”) and its checksum 44 are attached. Furthermore, the bus connection module 30 of the bus subscriber 26 produces a second frequency signal 52, which is not the same as the first frequency signal 48 from the field bus system 10. Together with the data value 42 and the checksum 44, the frequency signal 52 forms the individual system identifier which is associated with the field bus system 12.

As is unavoidable in the case of radio channels, the radio signal transmitted by the bus subscriber 18 also reaches bus subscriber 24 which is located in its physical proximity, as is indicated schematically by the arrow 54. However, the bus connection module 30 of the bus subscriber 24 uses the different system identifiers, in particular the different data values “0815” and “4711” as well as the frequency signals 48 and 52, to identify that the received bus message is associated with a different field bus system, namely the field bus system 10. The bus message received according to arrow 54 is thus ignored in the bus subscriber 24. Mutual interference is thus precluded between the field bus systems 10 and 12, which are of the same type, and in which the bus messages 46, 50 can intrinsically be exchanged on the basis of the identical communication protocols.

If, by way of example, the bus message 46 is a switch-on command for the associate machine system, then this switch-on command is ignored by the machine system associated with the field bus system 12. The field bus systems 10 and 12 thus have the necessary safety for controlling safety-critical processes.

In one preferred variant of this exemplary embodiment, the two field bus systems 10 and 12 operate using different carrier frequencies for radio transmissions. The carrier frequencies may in this case at the same time include the function of the different frequency signals 48, 52. As an alternative to this, the different frequency signals 48, 52 may, however, once again be dedicated signals, which are modulated onto different carrier frequencies. Assuming correct operation, the field bus system 12 can never receive a bus message 46 from the field bus system 10 in either case. The same is true in the converse sense. However, if one bus message were nevertheless “to go astray” owing to a fault or error, for example owing to an incorrect frequency shift or owing to inadvertently incorrect adjustment of the carrier frequency after carrying out a maintenance measure, the incorrectly received bus message would be ignored as a consequence of the measures described above. In addition, in this preferred exemplary embodiment, the entire field bus system which received the incorrect bus message would then be transferred to a safe fault state, for example being switched off. In consequence, the fault that has occurred will be signalled, thus avoiding a safety-critical situation.

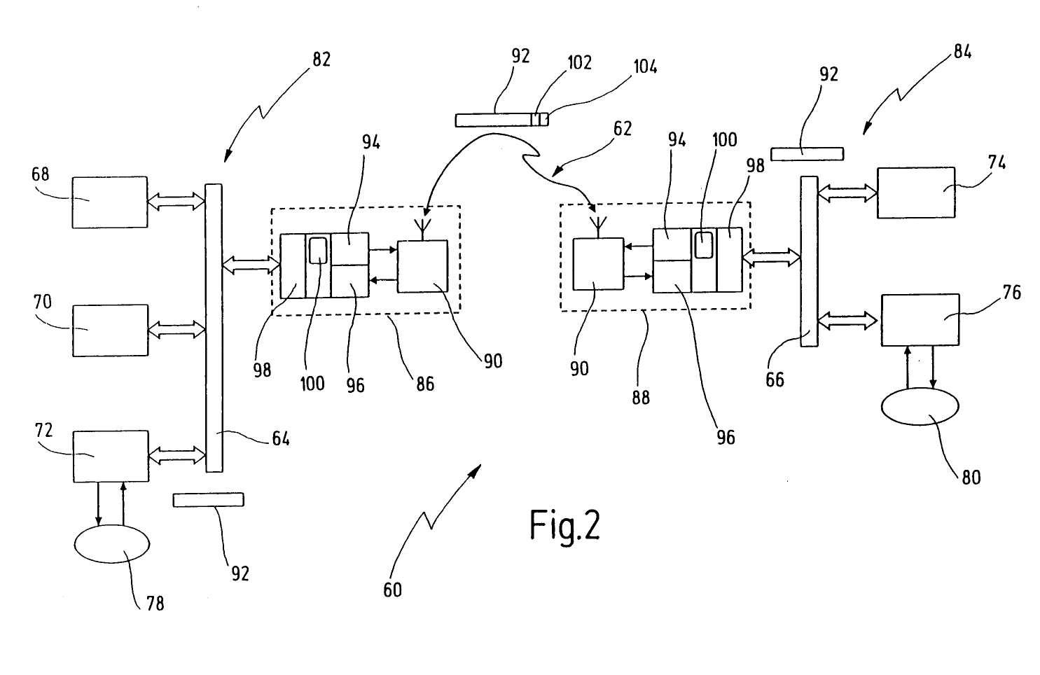

In FIG. 2, a field bus system according to the invention is annotated in its totality by reference number 60.

The field bus system 60 includes a radio channel 62 as the transmission medium. Alternatively, the radio channel 62 could once again be an open cable connection, such as an Ethernet connection which is also used for some other purpose.

Furthermore, the field bus system 60 has two closed (dedicated) cable connections 64, 66, to each of which a large number of bus subscribers 68, 70, 72, 74, 76 are connected. By way of example, the bus subscribers 68 and 70 each are light barriers, which have a corresponding bus connection module (not shown here). The bus subscriber 72 is a safe I/O device, the bus subscriber 74 is a safe control unit, and the bus subscriber 76 is once again a safe I/O device. Both the safe control unit 74 and the I/O devices have bus connection modules, which are not illustrated here. I/O device 72 is connected via inputs and outputs to a first safety-critical process 78, and the I/O device 76 is connected to a second safety-critical process 80. By way of example, this relates to the process of switching off sub areas of a complex machine system, wherein the switching-off is signalled via the inputs of the I/O devices 72, 76 to the safe control unit 74.

The bus subscribers 68 to 72 are connected via the cable connection 64 to form a first cable-based subsystem 82. The bus subscribers 74, 76 are connected via the cable connection 66 to form a second cable-based subsystem 84. The subsystems 82, 84 are, on their own, cable-based field bus systems of the type which is known from the German journal cited initially.

Reference numbers 86 and 88 each denote a signal converter, which connects cable connections 64, 66 to the radio channel 62. The two subsystems 82, 84 are thus connected to one another.

Each of the two signal converters 86 has a radio module 90 which can transmit and receive bus messages 92 via the radio channel 62. The radio modules 90 are standard modules which are known per se but which do not have the required fail-safety in the sense of European Standard EN 954-1, if seen on their own.

Furthermore, each signal converter 86, 88 has a first safety stage 94, a second safety state 96, a filter stage 98 and a smart card 100.

In the first safety stage 94, a bus message 92 to be transmitted via the radio channel 62 is provided with an individual system identifier 102 and with an associated checksum 104. In this case, the first safety stage 94 receives the system identifier 102 from the smart card 100. The identified bus message is then transmitted to the radio module 90, and, from there, it is transmitted via the radio channel 62. On receiving the identified bus message 92, the second safety stage 96 checks the attached system identifier 102 as well as its checksum 104 to determine whether the bus message 92 is actually associated with the field bus 60. The bus message 92 is not processed any further unless this is the case. Otherwise, the bus message 92 is rejected. This prevents an external bus message from being passed to one of the bus subscribers 68 to 76.

The filter stage 98 selects bus messages 92 on the basis of whether they are addressed to a receiver at the respective end of the radio channel 62. The filter stage 92 does not pass the bus message 92 to the first safety stage 94 or to the radio module 90 unless this is the case. This means that there is no unnecessary message traffic load on the radio channel 62.

In a further exemplary embodiment, the bus message 92 has only the system identifier 102, or alternatively only the checksum 104, added to it. Even this allows unique identification of the bus messages at the receiver end. In further exemplary embodiments, only one frequency signal is used, in a corresponding manner to the first exemplary embodiment to the system identifier.

What is claimed is:

1. A method of controlling safety-critical processes in an automated installation, the method comprising the steps of:
providing a field bus system comprising a transmission medium having an open communication channel, and comprising a plurality of bus subscribers connected to the transmission medium, with the bus subscribers being configured to transmit bus messages across the transmission medium for communicating with each other thereby monitoring and controlling the safety-critical processes, and
providing a defined communication protocol which predetermines rules for the transmission and reception of the bus messages across the transmission medium,
wherein the communication protocol includes a system identifier individually set to identify the field bus system and distinguish it as an entity uniquely from other field bus systems of the same type, and
wherein the system identifier is combined with each bus message transmitted across the open communication channel.

2. The method of claim 1, wherein the system identifier is selected to be the same for all bus messages transmitted in the field bus system.

3. The method of claim 1, wherein the bus subscribers monitor emergency-stop switches, two-handed controllers, guard doors and/or light barriers for controlling the automated installation.

4. The method of claim 1, wherein the individual system identifier is intrinsically redundant.

5. The method of claim 1, wherein the individual system identifier includes a defined frequency signal which is transmitted with the bus messages across the open communication channel.

6. The method of claim 1, wherein the individual system identifier includes a data value which is transmitted as a part of the bus messages.

7. The method of claim 6, wherein the data value is autonomously protected against data errors.

8. The method of claim 1, wherein the transmission medium further comprises a closed communication channel and a signal converter connecting the closed communication channel and the open communication channel.

9. The method of claim 8, wherein the signal converter comprises a first safety stage which connects the system identifier to any bus message to be transmitted across the open communication channel.

10. The method of claim 8, wherein the signal converter comprises a second safety stage which checks the system identifier of any bus message received across the open communication channel.

11. The method of claim 8, wherein the signal converter comprises a filter stage which selects any bus messages to be transmitted across the open communication channel, while it suppresses any bus messages not to be transmitted across the open communication channel.

12. The method of claim 8, wherein the signal converter comprises an interchangeable storage medium on which the system identifier is stored in a non-volatile manner.

13. The method of claim 1, wherein each bus subscriber comprises an interchangeable storage medium on which the system identifier is stored in a non-volatile manner.

14. The method of claim 13, wherein the interchangeable storage medium further comprises an individual subscriber address also stored in a non-volatile manner.

15. The method of claim 1, wherein the open communication channel is a radio channel.

16. The method of claim 1, wherein the open communication channel is an Ethernet link.

17. A field bus system for controlling safety-critical processes in an automated installation, the system comprising a transmission medium and a plurality of bus subscribers which are connected to the transmission medium, with the bus subscribers being configured to transmit bus messages across the transmission medium for communicating with each other, the system further comprising a defined communication protocol, which sets rules for the transmission and reception of the bus messages, wherein the transmission medium comprises an open communication channel, and the communication protocol includes an individual system identifier which is combined with each bus message transmitted across the open communication channel.

18. The field bus system of claim 17, wherein the individual system identifier is intrinsically redundant.

19. The field bus system of claim 17, wherein the individual system identifier includes a defined frequency signal, which is transmitted with the bus messages across the open communication channel.

20. The field bus system of claim 17, wherein the individual system identifier includes a data value which is transmitted as a component of the bus messages.

21. The field bus system of claim 20, wherein the data value is autonomously protected against data errors.

22. The field bus system of claim 17, wherein the transmission medium further comprises a closed communication channel and a signal converter for connecting the closed communication channel to the open communication channel.

23. The field bus system of claim 22, wherein the signal converter comprises a first safety stage which combines any bus message to be transmitted across the open communication channel with the system identifier.

24. The field bus system of claim 22, wherein the signal converter comprises a second safety stage which checks the system identifier of any bus message received across the open communication channel.

25. The field bus system of claim 22, wherein the signal converter comprises a filter stage which selects any bus messages to be transmitted across the open communication channel, while it suppresses any bus messages not to be transmitted across the open communication channel.

26. The field bus system of claim 22, wherein the signal converter has an interchangeable storage medium on which the system identifier is stored in a non-volatile manner.

27. The field bus system of claim 17, wherein each bus subscriber has an interchangeable storage medium on which the system identifier is stored in a non-volatile manner.

28. The field bus system of claim 27, wherein the interchangeable storage medium further comprises an individual subscriber address also stored in a non-volatile manner.

29. The field bus system of claim 17, wherein the open communication channel is a radio channel.

30. The field bus system of claim 17, wherein the open communication channel is an Ethernet link.

31. A bus connection module for use in a field bus system for controlling safety-critical processes, the module comprising an interface for connecting a bus subscriber to a transmission medium and comprising a communication unit in which a communication protocol is implemented, wherein the interface is an open communication interface, and wherein the implemented communication protocol includes a system identifier configured to be individually set, which system identifier identifies the field bus system as an entity uniquely from other field bus systems of the same type, said interface being configured to combine the system identifier to any bus message to be transmitted.

32. The bus connection module of claim 31, further comprising an interface for an interchangeable storage medium in which the individual system identifier is stored in a nonvolatile manner.
